(19) United States
(12) Patent Application Publication
(10) Pub. No.: US 2025/0153472 A1
(43) Pub. Date: May 15, 2025

(54) POLYMER-BASED CONSTRUCTION MATERIALS

(71) Applicant: The AZEK Group LLC, Chicago, IL (US)

(72) Inventors: Jia FAN, Mason, OH (US); Christopher Michael Barr, Hamilton, VA (US)

(21) Appl. No.: 18/945,465

(22) Filed: Nov. 12, 2024

Related U.S. Application Data
(60) Provisional application No. 63/598,519, filed on Nov. 13, 2023.

(51) Int. Cl. B32B 27/08; B32B 3/04; B32B 7/02; B32B 27/32; C08L 23/06; C08L 23/12; E04F 15/02; E04F 15/10

(52) U.S. Cl. CPC B32B 27/08; B32B 3/04; B32B 7/02; B32B 27/32; C08L 23/06; C08L 23/12; E04F 15/02183; E04F 15/107; B32B 2250/03; B32B 2250/24; B32B 2270/00; B32B 2272/00; B32B 2307/7376; B32B 2419/00; C08L 2207/062; C08L 2207/20

(57) ABSTRACT

Aspects described herein relate to polymer-based building materials that include combining thermoplastic and thermoset polymers to the polymer-based cap. By including thermoset polymers, deficiencies in polymer-based construction materials can be address. The addition of thermoset polymers may facilitate improved scratch, abrasion and slip resistance for polymer-based building materials.

This application having entitled “Polymer-Based Construction Materials” claims the benefit of priority of U.S. App. No. 63/598,519, filed Nov. 13, 2023, and entitled “Polymer-Based Construction Materials.” The entirety of the aforementioned application is incorporated by reference herein.

### TECHNICAL FIELD

Aspects hereof relate to polymer-based construction materials comprising combining a thermoplastic polymer and a thermoset polymer, wherein the thermoset polymer is a cross-linked high density polyethylene.

### BRIEF SUMMARY

Man-made alternatives to naturally occurring materials such as wood can provide a number of advantages in construction and consumer products. For example, wood can rot, warp, splinter, discolor or bleach; while polymer-based materials, such as materials that have an outer layer made of high-density polyethylene (HDPE), may be dent and impact resistant, resist rotting, include UV resistant additives, be sealed to prevent discoloration, and so on. The combination of wood fibers and plastic (e.g., HDPE, low-density polyethylene (LDPE), etc.) gives composite decking some of the aesthetics of wood while benefiting from the durability and low maintenance of plastic.

Although traditional polymer-based decking materials offer several advantages, they do come with certain disadvantages. For example, even though polymer-based decking is designed to resist scratching better than uncapped composites, it is still susceptible to marring or dents from furniture, pet claws, and other sharp objects. Another disadvantage with traditional polymer-based decking is low slip resistance when the surface of the polymer-based material is wet.

Attempts have been made to manufacture polymer-based construction materials with enhanced slip resistance and scratch resistance to address consumer concerns and improve the longevity and safety of traditional HDPE capped decking materials. For example, several manufacturers have incorporated textured surfaces into their products, mimicking the grain of real wood to help with slip resistance when wet. However, textured surfaces can be challenging to clean. Additionally, high traffic or heavy use can cause uneven wear over time, which diminishes the intended functional benefits of the texture. Textured surfaces also present a challenge when it comes to achieving a consistent look across the surface. For example, maintaining consistency of textured surfaces can be difficult when, or if, the surface were to need repairs.

Other attempts to increase scratch resistance include incorporation of reinforcing additives, such as adding some mineral compositions to the composite mix to enhance the overall durability and scratch resistance. Increasing inorganic mineral content can improve scratch resistance. However, excessive amounts may lead to unintended consequences, such as scratch whitening, where scratches appear more visibly white against the material's surface. Further, traditional reinforcing materials, particularly certain fibers or minerals, can increase the weight of the composite, which may not be desirable for lightweight applications. Incorporating these fibers and minerals may complicate the manufacturing process, requiring specialized equipment, additional processing steps, and more rigorous quality control. Additionally, some inorganic mineral reinforcements tend to absorb or interact with pigments differently than the polymer matrix (e.g., HDPE), resulting in inconsistencies in color distribution. This differential pigment interaction may further highlight any scratches that do form, reducing the material's overall aesthetic appeal.

Accordingly, aspects described herein provide for polymer-based building materials including a thermoplastic polymer and a thermoset polymer as well as systems and methods for producing the same.

### DESCRIPTION OF THE DRAWINGS

The present invention is described in detail herein with reference to the attached drawing figures, wherein:

FIG. 1 depicts a perspective view of an example polymer-based building material, in accordance with aspects hereof;

FIG. 2A depicts a cross sectional view of example multicomponent polymer-based construction materials including a thermoplastic polymer and a thermoset polymer, in accordance with aspects hereof;

FIG. 2B depicts a cross sectional view of example multicomponent polymer-based construction materials including a thermoplastic polymer and a thermoset polymer, in accordance with aspects hereof;

FIG. 2C depicts a cross sectional view of example multicomponent polymer-based construction materials including a thermoplastic polymer and a thermoset polymer, in accordance with aspects hereof;

FIG. 2D depicts a cross sectional view of example multicomponent polymer-based construction materials including a thermoplastic polymer and a thermoset polymer, in accordance with aspects hereof;

FIG. 3A depicts a side-by-side comparison of the scratch resistance of traditional HDPE decking materials versus cross-linked HDPE decking materials, in accordance with aspects hereof;

FIG. 3B depicts a side-by-side comparison of the scratch resistance of traditional HDPE decking materials versus cross-linked HDPE decking materials, in accordance with aspects hereof;

FIG. 3C depicts a side-by-side comparison of the scratch resistance of traditional HDPE decking materials versus cross-linked HDPE decking materials, in accordance with aspects hereof;

FIG. 3D depicts a side-by-side comparison of the scratch resistance of traditional HDPE decking materials versus cross-linked HDPE decking materials, in accordance with aspects hereof;

FIG. 4 depicts a table and line graph of a Taber Abrasion Test, in accordance with aspects hereof; and

FIG. 5 depicts a flow chart of a method for the production of a polymer-based building material, in accordance with aspects hereof.

### DETAILED DESCRIPTION

As mentioned above, using polymer-based construction materials can provide a number of advantages in construction and consumer products compared to their naturally occurring counterparts. However, traditional HDPE capped decking materials are susceptible to marring or dents, and can be slippery when the surface is wet.

Some aspects described herein overcome these problems and provide polymer-based construction materials, systems, and methods for producing polymer-based construction materials that combine a thermoplastic polymer with a thermoset polymer. Embodiments described herein allow for the retention of key thermoplastic properties while incorporating thermoset characteristics to form the cap, distinguishing it from traditional cross-linking approaches.

Typically, cross-linking has involved treating the entire polymer matrix via secondary processes (such as electron beam irradiation or UV irradiation), or through comprehensive reactive extrusion using cross-linking agents, such as peroxide. These traditional methods generally involve stationary, secondary treatments that cross-link the outer surfaces of the polymer more intensely than the interior. In other words, cross-linking is most concentrated at the surface, with less cross-linking occurring toward the interior, due to limited penetration depth of UV or e-beam radiation, leading to inconsistent performance across the material. Moreover, these traditional processes present several challenges, including the need for additional equipment, complex quality control, and precise adjustment of treatment parameters to control cross-linking ratios and distribution, which can lead to reproducibility issues and increased production costs.

In contrast, the approach described herein integrates ground cross-linked polyethylene (PEX) directly into the thermoplastic HDPE matrix, creating a homogeneous, non-gradient distribution of cross-linked particles throughout the thickness of the cap. This uniform structure allows for consistent cross-linking proportions, ensuring that the cap retains key thermoplastic properties while incorporating thermoset characteristics in a balanced manner—achieving a harder, more durable surface without compromising the thermoplastic's inherent benefits. Moreover, this method eliminates the need for additional equipment, complex quality control, and precise treatment adjustments required by traditional cross-linking techniques, simplifying manufacturing and improving reproducibility. Additionally, it may allow for selective customization of the cross-linked content within the thermoplastic, providing a balance of properties from both polymer types.

For example, adding a thermoset polymer, such as cross-linked HDPE, into the traditional thermoplastic polymer HDPE may facilitate formation of a capped decking material having comparatively improved slip, scratch, marring, and heat resistance. Cross-linked HDPE is often referred to as PEX, and is a form of HDPE that has undergone a chemical or physical process to create covalent bonds (i.e., cross-links) between its polymer chains. The cross-linking results in a modified HDPE with improved properties compared to conventional HDPE, including thermal stability, chemical resistance, durability, creep resistance, and the like. Once the HDPE undergoes the cross-linking process, it effectively changes its nature from a thermoplastic polymer to a thermoset polymer.

In aspects, incorporating ground PEX into the thermoplastic matrix may produce a more uniform distribution of cross-linking throughout the material thickness compared to traditional methods. While the extrusion process may cause some particles to migrate slightly toward the surface, this gradient effect is minimal compared to the pronounced layering seen in traditional methods. The screw shear within the extrusion process further promotes even dispersion of PEX particles, ensuring consistent integration.

In aspects, cross-linked HDPE (i.e., PEX) is incorporated into traditional thermoplastic HDPE to produce a capped decking material with improved durability. This controlled integration may enable the retention of essential thermoplastic characteristics with additional benefits such as increased thermal stability, chemical resistance, flexibility, and creep resistance-without the need for secondary processes like UV or E-beam irradiation that often make materials difficult to reprocess. Additionally, residual peroxide within the PEX material may facilitate controlled cross-linking during processing, enhancing the material's properties. Thus, the PEX may act as a functional filler rather than a simple additive, contributing actively to the enhanced durability, scratch resistance, slip resistance, and heat resistance of the final product. Importantly, the thermoplastic matrix retains its recyclability and reprocessability, as the cross-linking is well-controlled and does not compromise the thermoplastic's core properties.

Accordingly, some aspects described herein are directed to a method of preparing a polymer-based building material. The method includes providing a first extruder with a first polymer-based mixture including a first amount of a thermoplastic polymer and a second amount of a thermoset polymer, where the first amount and second amount are different. The first polymer-based mixture is heated along a length of the first extruder and then extruded, wherein the first polymer-based mixture includes the thermoplastic polymer and the thermoset polymer.

Another aspect described herein is directed to a polymer-based building material. The polymer-based building material includes a core having a first thickness extending between a first planar surface and a second planar surface. The polymer-based building material also includes a cap that is adjacent at least the first planar surface and includes a thermoplastic polymer and a thermoset polymer.

Another aspect described herein is directed to a polymer-based building material. The polymer-based building material includes a core having a first planar surface and a second planar surface. The polymer-based building material also includes a cap that is adjacent to the first planar surface and includes a polymeric composition having a thermoplastic polymer and a thermoset polymer, wherein the thermoset polymer in the polymeric composition is in a range of up to 20% by weight.

Yet another aspect described herein is directed to a polymer-based building material. The polymer-based building material includes a first cap portion having a first thickness, wherein the first cap portion extends between a first planar surface and a second planar surface and includes a thermoset polymer and a thermoplastic polymer. The polymer-based building material also includes a core that is adjacent to at least the second planar surface, wherein the first cap portion at least partially covers an outer surface of the core.

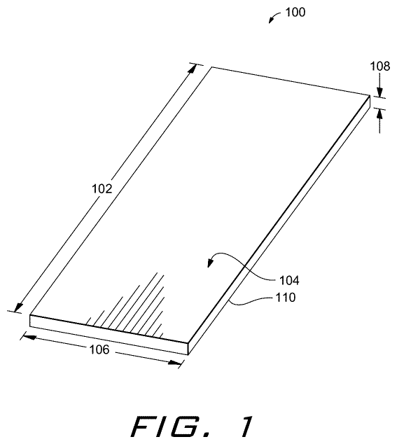

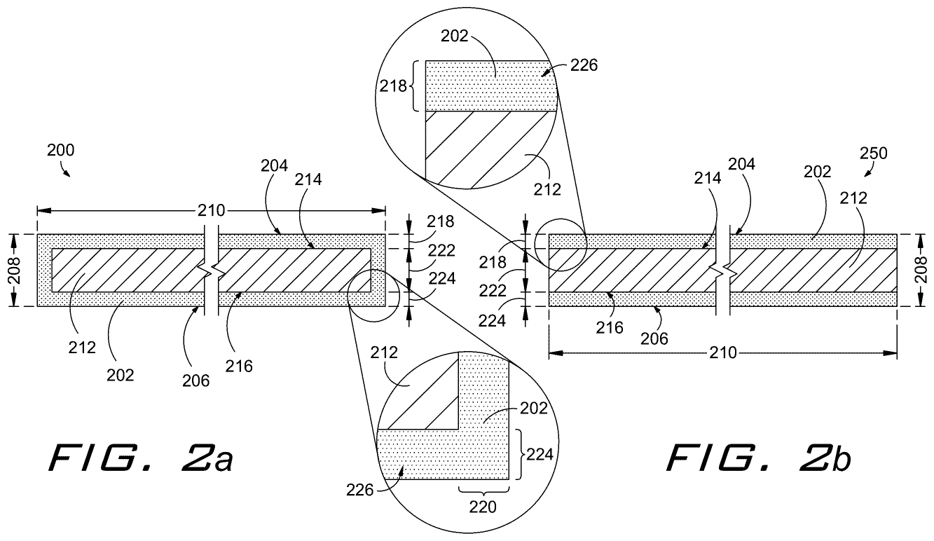

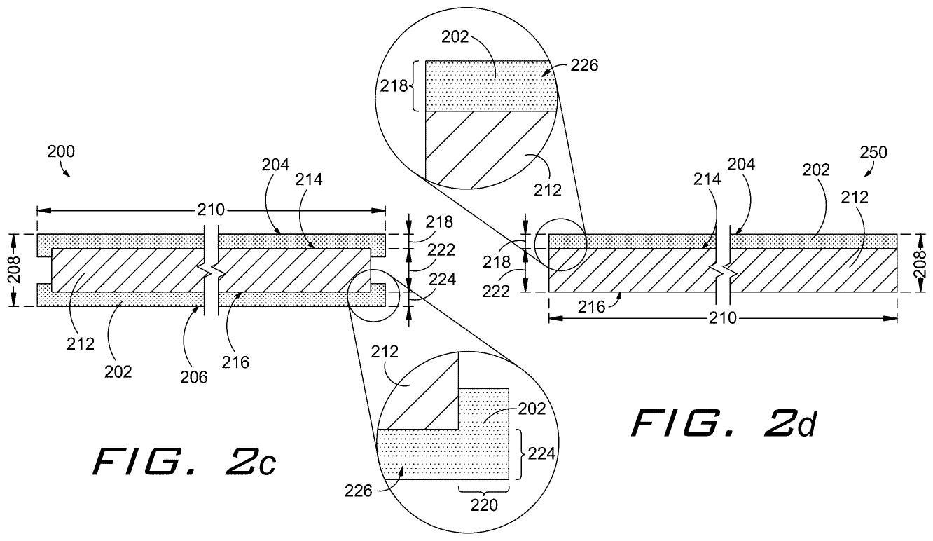

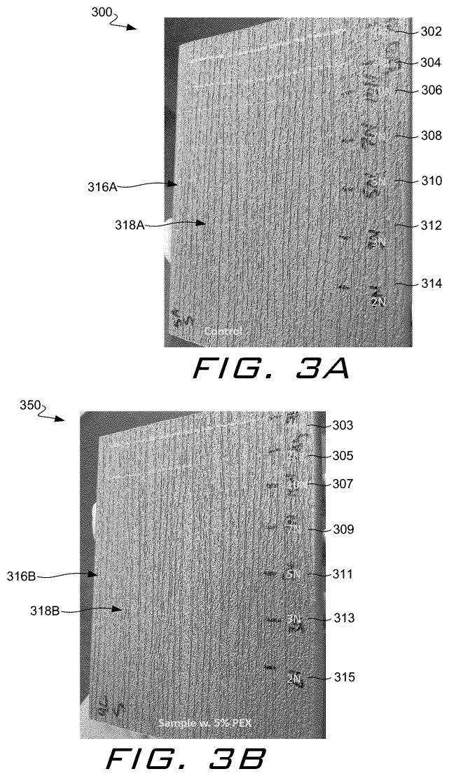

With respect to FIG. 1, an example polymer-based construction material 100 is provided in accordance with aspects described herein. Some aspects of polymer-based construction material 100 comprise one or more polymeric resin mixtures are co-extruded to form a cap and a core (such as discussed in reference to FIGS. 2A to 2D). The polymer-based construction material 100 may be a trim component (e.g. trim board), a siding component (e.g. siding board, siding shingle, or a siding sheet), a roofing component (e.g. roofing board, roofing shingle, roofing sheet), a decking component (e.g. decking board, decking sheet, deck flooring, deck railing), a decorative or functional construction accessory, or any other construction material(s). Some aspects of polymer-based construction material 100 may be manufactured by an extrusion system. In some embodiments, the construction material 100 may be incorporated into finished products such as furniture.

The polymer-based construction material 100 comprises a length 102, a width 106, and gauge (thickness) 108. The length 102 may be any length and may vary based on the intended use. For example, the length 102 is between 0.5 feet (ft.) and 60 ft. in some aspects. However, it is contemplated that length 102 can be any length.

The width 106 may be any value and may vary based on the intended use. For example, a polymer-based material intended for use as a siding component may be a first width, while a polymer-based construction material intended for use as a trim board may be a second width, while a polymer-based construction material intended for use as a construction accessory may be a third width, and so on. Additionally, in some aspects, a polymer-based construction material (such as construction material 100) can be cut into a selectable combination of uniform and/or non-uniform widths.

The gauge 108 may be any thickness and may vary based on the intended use. In some aspects, the gauge 108 is between 0.10 inches and 3.00 inches. In some aspects, the gauge 108 is between 0.125 inches and 2.00 inches. In some aspects, the gauge 108 is between 0.25 inches and 1.75 inches. In some aspects, the gauge 108 is between 0.5 inches and 1.25 inch. In an aspect, the gauge 108 is 0.25 inches.

Polymer-based construction material 100 also comprises a first primary surface 104 and a second primary surface 110. The primary surfaces 104, 110, or both are generally the surfaces intended for exposure or contact during normal use. For example, where the polymer-based construction material has an intended end use as a board in a deck, the primary surface of the polymer-based construction material would form part of the decking surface intended for contact with users of the deck.

Turning to FIGS. 2A through 2D, a cross section of an example multicomponent polymer-based construction materials 200, 230, 240, and 250 are provided in accordance with aspects described herein. Multicomponent polymer-based construction materials 200, 230, 240, and 250 include a polymer-based cap 202 and a polymer-based core 212. In some aspects, the polymer-based cap 202 is adjacent at least a first planar surface 214. Additionally, or alternatively, the polymer-based cap 202 can include a first cap portion 204 adjacent the first planar surface 214 of the polymer-based core 212 and a second cap portion 206 adjacent a second planar surface 216 of the polymer-based core 212.

The polymer-based cap 202 comprises a first polymer-based mixture including a thermoplastic polymer and a thermoset polymer. The thermoset polymer may include cross-linked HDPE (i.e., PEX) in some aspects. The thermoplastic polymer of the polymer-based cap 202 may be in a range of up to 20% by weight of the first polymer-based mixture. For example, in an aspect, the thermoset polymer is 5% by weight of the first polymer-based mixture. In at least one aspect, the thermoplastic polymer of the first polymer-based mixture includes one or more HDPE, LDPE, or polypropylene (PP) and comprises at least 80% of a polymer-based mixture by weight. The thermoplastic polymer of the first polymer-based mixture may include one or more recycled polymers and/or virgin polymers in some aspects. As used herein, a virgin polymeric resin refers to a resin that includes at least one polymer that is not recycled or a recovered scrap. As used herein, a recycled polymer is a polymer that has been processed from post-consumer or post-industrial plastic waste. Instead of these plastics ending up in landfills or being incinerated, they are collected, processed, and then remanufactured into new plastic products. For example, the thermoplastic polymer may include recycled ultra-high molecular weight polyethylene (UHMWPE), recycled HDPE, recycled low density polyethylene (LDPE) or any combination thereof. Additionally, in at least one aspect, the polymer-based cap 202 does not comprise cellulose.

The polymer-based core 212 can comprise a second polymer-based mixture that is different from the first polymer-based mixture, and includes a second thermoplastic polymer. In some aspects the polymer-based core 212 can comprise a filler. The filler is a material added to the polymer to enhance certain properties, reduce product cost, incorporate recycled materials, or any combination thereof. Some examples of fillers include wood fibers or flour, mineral fillers, glass fibers, carbon black, and recycled materials. The exact formulation of the core mixture, including the type and proportion of the filler can vary. The core has a first thickness extending between the first planar surface 214 and the second planar surface 216. Alternatively, the polymer-based core 212 includes a first core portion (not shown) perpendicularly connecting the first planar surface 214 to the second planar surface 216. In some embodiments, the polymer-based cap 202 can be used as a single layer on building products and there may not be a different material used for the polymer-based core 212. In other words, the entire profile may be completely formed from the polymer mix that forms the polymer-based cap 202.

As depicted in FIG. 2A, in some aspects the first cap portion 204 and the second cap portion 206 of the polymer-based cap 202 can encapsulate the polymer-based core 212. In such aspects the gauge 220 of the encapsulating portion can be any gauge. The polymer-based cap 204, 206 can encapsulate the polymer-based core 212 with a third cap portion 205. The third cap portion 205 is a joining cap member and is perpendicular to the first cap portion 204 and the second cap portion 206 and surrounds at least a portion of the polymer-based core 212. However, it is also contemplated that the first cap portion 204 and the second cap portion 206 of the polymer-based cap 202 are co-extensive with the first planar surface 214 and the second planar surface 216 of the polymer-based core 212 as depicted in FIG. 2B. Further, as depicted in FIG. 2C, in some aspects, the first cap portion 204 and the second cap portion 206 can partially encapsulate the polymer-based core 212. Said another way, the first cap portion 204 can include a subsection that is adjacent to at least a portion of the polymer-based core 212 (i.e. a first core portion). The first core portion can perpendicularly connect the first planar surface 214 to the second planar surface 216. Additionally, the first cap portion 204 can have a first thickness and the second cap portion 206 can have a second thickness that is different from the first thickness. In other aspects, as depicted in FIG. 2D, the core is only encapsulated by the first cap portion 204, which is only touching the polymer-based core 212 on the first planar surface 214.

Continuing with reference FIGS. 2A through 2D, the multicomponent polymer-based construction materials 200, 230, 240, and 250 have a gauge (thickness) 208 and a width 210. The gauge 208 of the multicomponent polymer-based construction materials 200, 230, 240, and 250 may be any thickness and may vary based on the intended use. For example, in some aspects, the gauge 208 is 0.25 inches (6.35 mm), 0.50 inches (12.7 mm), 1.00 inches (25.4 mm), 1.25 inches (31.75 mm), or 1.50 inches (38.1 mm). In some aspects, the gauge 208 is within the range of 0.25 inches (6.35 mm) and 1.50 inches (38.1 mm). The first cap portion 204 has a gauge 218 and the second cap portion 206 has a gauge 224. The gauges 218 and 224 may be any thickness and may vary based on the intended use. For example, in some aspects, gauges 218 or 224 are 0.025 inches (0.635 mm), 0.050 inches (1.27 mm), 0.0625 inches (1.5875 mm), 0.0714 inches (1.814 mm), 0.0833 inches (2.117 mm), 0.0875 inches (2.225 mm), 0.125 inches (3.175 mm), 0.25 inches (6.35 mm), 0.50 inches (12.7 mm), or 0.625 inches (15.875 mm). The gauge 222 of the polymer-based core 212 may be any thickness and may vary based on the intended use. For example, in some aspects, the gauge 222 is 0.125 inches (3.175 mm), 0.175 inches (4.445 mm), 0.25 inches (6.35 mm), 0.50 inches (12.7 mm), 1.00 inches (25.4 mm), or 1.25 inches (31.75 mm).

The width 210 of the multicomponent polymer-based construction materials 200, 230, 240, and 250 may be any width and may vary based on the intended use. For example, in some aspects, the width 210 is 3 inches (76.2 mm) or 152 inches (3860.8 mm). In some aspects, the width 210 is between 3 inches (76.2 mm) and 152 inches (3860.8 mm).

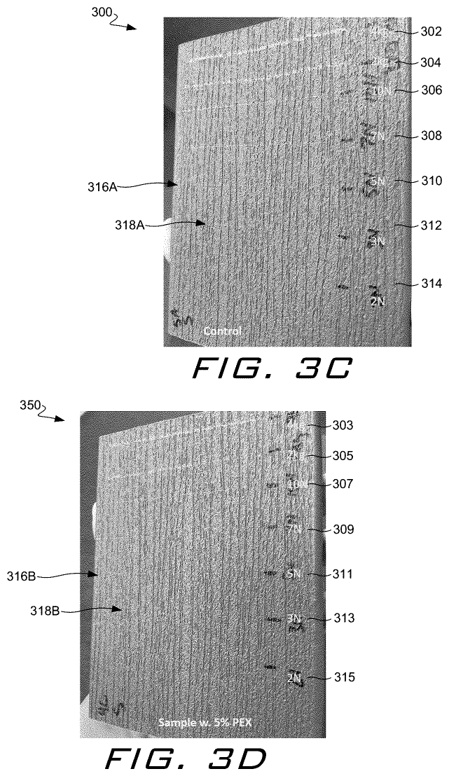

Turning to FIGS. 3A through 3D, FIGS. 3A and 3B are a side-by-side comparison 300 and 350 of the scratch resistance of traditional HDPE decking materials versus cross-linked HDPE decking materials, in accordance with aspects hereof. FIG. 3C is a black and white version of FIG. 3A and includes the same reference numbering; it will be discussed jointly as it represents the same information. Similarly, FIG. 3D is a black and white version of FIG. 3B and includes the same reference numbering; it will be discussed jointly as it represents the same information. In these aspects, the traditional HDPE deck 300 is compared to the sample HDPE deck 350 includes 5% PEX in the cap. In the side-by-side comparison, both the traditional HDPE deck 300 and the sample HDPE deck have had different loads of force applied to the surface using a scratch probe. For example, at location 302 a force of 4 kg has been applied to the traditional HDPE deck 300, and in comparison, at 303, a force of 4 kg has been applied to the sample HDPE deck 350. To continue, at 304 a force of 2 kg has been applied to the traditional HDPE deck 300, and in comparison, at 305, a force of 2 kg has been applied to the sample HDPE deck 350. At 306 a force of 10N has been applied to the traditional HDPE deck 300, and in comparison, at 307, a force of 10N has been applied to the sample HDPE deck 350. At 308 a force of 7N has been applied to the traditional HDPE deck 300, and in comparison, at 309, a force of 7N has been applied to the sample HDPE deck 350. At 310 a force of 5N has been applied to the traditional HDPE deck 300, and in comparison, at 311, a force of 5N has been applied to the sample HDPE deck 350. At 312 a force of 3N has been applied to the traditional HDPE deck 300, and in comparison, at 313, a force of 3N has been applied to the sample HDPE deck 350. And finally, at 314 a force of 2N has been applied to the traditional HDPE deck 300, and in comparison, at 315, a force of 2N has been applied to the sample HDPE deck 350. When comparing the scratch marks from the different levels of force on the traditional HDPE deck 300 and the sample HDPE deck 350, the scratch marks 303, 305, 307, 309, 311, 313, and 315 show less to no visible scratch marks under 7N 309, 5N, 311, and 3N 313 when compared to the scratch marks of the traditional HDPE deck 300 at 302, 304, 306, 308, 310, 312, and 314. For example, reference number 316A points to the scratch mark caused from a 5N force 310 applied to the traditional HDPE deck 300. The reference number 316B points to the scratch mark caused by a 5N force 311 being applied to the sample HDPE deck 350. As is depicted in the example provided in FIGS. 3A and 3B, the mark 316B is less visible in the sample HDPE deck 350 than the mark 316A in the traditional HDPE deck 300. In aspects, reference number 318A points to the abrasion from 3N of force 312 being applied to the traditional HDPE deck 300. The reference number 318B points to the scratch mark from 3N of force 313 being applied to the sample HDPE deck 350. As is depicted in the example provided in FIGS. 3A and 3B, the mark 318B is less visible in the sample HDPE deck 350 than the mark 318A. Said differently, there is very little marking in the sample that includes the sample HDPE deck 350 having 5% PEX compared to the traditional HDPE sample 300.

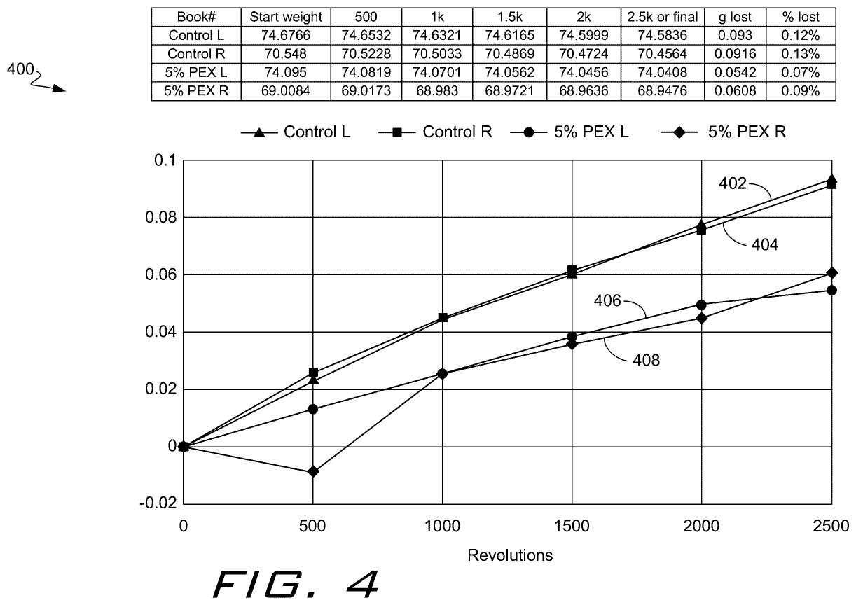

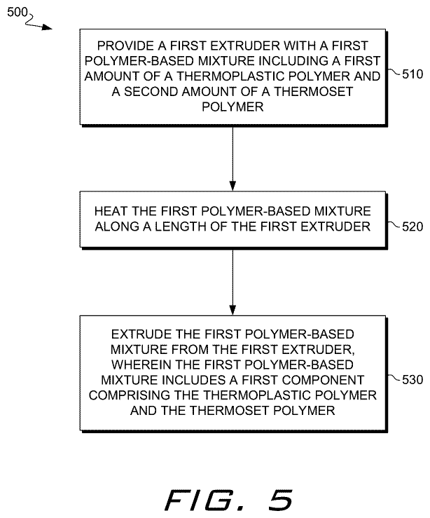

With reference to FIG. 4, results from a Taber Abrasion Test (Taber Test) in accordance with aspects herein. The Taber Test is a method used to determine the wear resistance of materials, including painted or coated surfaces, plastics, textiles, and the like. The test quantifies the ability of a material to withstand the wear that occur due to its normal use. A sample of the material is cut to size and mounted on the turntable platform where two abrasive wheels are placed at a specific angle and a specific weight is applied to the wheels to provide a consistent downward force. The sample is then rotated at a fixed speed, causing the abrasive wheels to wear away at the material and the wear on the sample is evaluated. This wear process is analyzed to assess the material's resilience. Table 400 of FIG. 4 represents results of a Taber Test. As shown, line 402 represents the control on the left abrasive wheel and line 404 represents the control on the right abrasive wheel. In aspects, the control is a traditional HDPE deck (such as the traditional HDPE deck 300 from FIG. 3). Line 406 represents the sample HDPE deck treated with 5% PEX on the left wheel and line 408 represents the samples HDPE deck treated with 5% PEX on the right wheel. In aspects, the sample HDPE deck treated with 5% PEX is the same as deck 350 from FIG. 3. The findings from Table 400 indicate that the control lines 402 and 404 experienced more wear (in grams) than the 5% PEX-treated lines 406 and 408. In simpler terms, the HDPE deck with 5% PEX demonstrated superior wear resistance compared to the standard HDPE deck. The PEX-infused HDPE deck was less prone to scratching and, when contrasted with a control, showed enhanced abrasion resilience. Turning to FIG. 5, a method 500 for the production of a polymer-based building material in accordance with aspects described herein is provided. In some aspects, method 500 can facilitate the production of a polymer-based building material (such as discussed in reference to FIGS. 2A through 2D).

Accordingly, in some aspects of block 510 a first extruder is provided with a first polymer-based mixture, including a first amount of a thermoplastic polymer and a second amount of a thermoset polymer, wherein the second amount is different from the first amount. In aspects, the thermoplastic polymer comprises recycled polymeric material that ranges from 20%-50% by weight. In other aspects, the thermoset polymer comprises a range of 0.1% and 20% by weight. In aspects, the thermoset polymer comprises a range of 10% and 20% by weight. In example aspects, the thermoset polymer comprises 15% by weight. In alternative aspects, the thermoset polymer comprises 13% by weight. In alternative aspects, the thermoset polymer comprises 11% by weight. In alternative embodiments, the thermoset polymer comprises a range of 1% and 9% by weight. In aspects, the thermoset polymer comprises a range of 2% and 8% by weight. In aspects, the thermoset polymer comprises a range of 3% and 7% by weight. In aspects, the thermoset polymer comprises a range of 4% and 6% by weight. For example, in a particular aspect, the thermoset polymer is 5% by weight. At block 520, the first polymer-based mixture is heated along a length of the first extruder. And finally at block 530, the first polymer-based mixture is extruded from the first extruder, wherein the first polymer-based mixture includes a first component comprising the thermoplastic polymer and the thermoset polymer. Additionally, or alternatively, the method could further comprise a second extruder with a second polymer-based mixture including a second thermoplastic polymer and a filler. The second polymer-based mixture can be co-extruded with the first polymer-based mixture, wherein the first polymer-based mixture at least partially surrounds at least one surface of the second polymer-based mixture (such as discussed in reference to FIGS. 2A through 2D).

The subject matter of the technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of the methods employed, the terms should not be interpreted as implying any particular order among or between various steps herein disclosed unless and except when the order of individual steps is explicitly described.

As used herein and in connection with the claims listed hereinafter, the terminology “any of clauses” or similar variations of said terminology is intended to be interpreted such that features of claims/clauses may be combined in any combination. For example, an exemplary clause 4 may indicate the method/apparatus of any of clauses 1 through 3, which is intended to be interpreted such that features of clause 1 and clause 4 may be combined, elements of clause 2 and clause 4 may be combined, elements of clause 3 and 4 may be combined, elements of clauses 1, 2, and 4 may be combined, elements of clauses 2, 3, and 4 may be combined, elements of clauses 1, 2, 3, and 4 may be combined, and/or other variations. Further, the terminology “any of clauses” or similar variations of said terminology is intended to include “any one of clauses” or other variations of such terminology, as indicated by some of the examples provided above.

Clause 1. A method of preparing a polymer-based building material, the method comprising: providing a first extruder with a first polymer-based mixture including a first amount of a thermoplastic polymer and a second amount of a thermoset polymer; heating the first polymer-based mixture along a length of the first extruder; and extruding the first polymer-based mixture from the first extruder, wherein the first polymer-based mixture includes a first component comprising the thermoplastic polymer and the thermoset polymer.

Clause 2. The method of clause 1, wherein the thermoset polymer comprises recycled polymeric material that ranges from 20%-50% by weight

Clause 3. The method of clause 1 or 2, wherein the thermoplastic polymer comprises one or more of recycled high density polyethylene (HDPE), recycled low density polyethylene (LDPE), or polypropylene (PP).

Clause 4. The method of any of clauses 1 through 3, wherein the thermoset polymer comprises a cross-linked high density polyethylene.

Clause 5. The method of any of clauses 1 through 4, wherein the thermoplastic polymer comprises at least 80% of the first polymer-based mixture by weight.

Clause 6. The method of any of clauses 1 through 5, wherein the thermoset polymer comprises a range of 0.1% and 20% by weight.

Clause 7. The method of any of clauses 1 through 6, wherein the thermoset polymer is 5% by weight.

Clause 8. The method of clauses 1 through 7, further comprising: providing a second extruder with a second polymer-based mixture including a second thermoplastic polymer and a filler; and co-extruding the second polymer-based mixture with the first polymer-based mixture, wherein the first polymer-based mixture at least partially surrounds at least one surface of the second polymer-based mixture

Clause 9. A polymer-based building material comprising: a first cap portion having a first thickness, wherein the first cap portion extends between a first planar surface and a second planar surface and includes a thermoplastic polymer and a thermoset polymer; and a core, the core adjacent at least the second planar surface, wherein the first cap portion at least partially covers an outer surface the core.

Clause 10. The building material of clause 9, further comprising a second cap portion having a second thickness that extends between a third planar surface and a fourth planar surface, and includes a thermoplastic polymer and a thermoset polymer.

Clause 11. The building material of clause 9 or 10, wherein the second cap portion is affixed to an outer surface of the core opposite the first cap portion, wherein the second cap portion at least partially covers the outer surface of the core on the third planar surface.

Clause 12. The building material of any of clauses 9 through 11, wherein the core has a first thickness extending between the second planar surface and the third planar surface.

Clause 13. The building material of any of clauses 9 through 12, wherein the thermoset polymer is a cross-linked high density polyethylene (HDPE).

Clause 14. The building material of any of clauses 9 through 13, wherein the thermoplastic polymer comprises one or more of recycled high density polyethylene (HDPE) or polypropylene (PP).

Clause 15. The building material of any of clauses 9 through 13, wherein the thermoplastic polymer comprises a virgin polymer.

Clause 16. The building material of any of clauses 9 through 15, wherein the cap does not comprise cellulose.

Clause 17. The building material of any of clauses 9 through 16, wherein the core includes a first core portion perpendicularly connecting the first planar surface to the second planar surface.

Clause 18. The building material of any of clauses 9 through 17, wherein the first cap portion includes a subsection that is adjacent to at least a portion of the first core portion.

Clause 19. The building material of any of clauses 9 through 18, wherein the first cap portion has a first thickness and the second cap portion has a second thickness.

Clause 20. The building material of any of clauses 9 through 19, wherein the first cap portion and the second cap portion are connected by a joining cap member that is perpendicular to the first cap portion and the second cap portion and surrounds at least a portion of the core.

Clause 21. The building material of any of clauses 9 through 20, wherein the thermoset polymer comprises a range of 0.1% and 20% by weight.

Clause 22. A polymer-based building material, comprising: a core having a first planar surface and a second planar surface; and a cap adjacent to the first planar surface, the cap including a polymeric composition having a thermoplastic polymer and a thermoset polymer, wherein the thermoset polymer in the polymeric composition is in a range of up to 20% by weight.

Clause 23. The building material of clause 22, wherein the thermoset polymer is a cross-linked high density polyethylene (HDPE).

Clause 24. The building material of any of clauses 22 through 23, wherein the thermoplastic polymer comprises one or more of recycled high density polyethylene (HDPE), polypropylene (PP), or a virgin polymer.

Clause 25. The building material of any of clauses 22 through 24, wherein the thermoplastic polymer comprises at least 80% of a polymer-based mixture by weight.

Clause 26. The building material of any of clauses 22 through 25, wherein the thermoset polymer is 5% by weight.

Clause 27. The building material of any of clauses 22 through 26, wherein the cap does not comprise cellulose.

Clause 28. The building material of any of clauses 22 through 27, wherein the core includes a first core portion perpendicularly connecting the first planar surface to the second planar surface.

Clause 29. The building material of any of clauses 22 through 28, wherein the cap further comprises: a first cap portion having a subsection that is adjacent to at least a portion of the first core portion; and a second cap portion, wherein the first cap portion has a first thickness and the second cap portion has a second thickness.

Clause 30. The building material of any of clauses 22 through 29, wherein the first cap portion and the second cap portion are connected by a third cap portion that is perpendicular to the first cap portion and the second cap portion and surrounds at least a portion of the core.

We claim:

1. A polymer-based building material, comprising:
a core having a first thickness extending between a first planar surface and a second planar surface; and
a cap, the cap adjacent to at least the first planar surface, the cap including a matrix comprising a thermoplastic polymer and a thermoset polymer,
wherein the thermoset polymer is uniformly distributed throughout the cap.

2. The building material of claim 1, wherein the cap includes a first cap portion adjacent the first planar surface of the core; and
a second cap portion adjacent the second planar surface of the core.

3. The building material of claim 1, wherein the thermoset polymer is a cross-linked high density polyethylene (HDPE).

4. The building material of claim 1, wherein the thermoplastic polymer comprises one or more of recycled high density polyethylene (HDPE), or polypropylene (PP).

5. The building material of claim 1, wherein the thermoplastic polymer is a virgin polymer.

6. The building material of claim 1, wherein the cap does not comprise cellulose.

7. The building material of claim 2, wherein the core includes a first core portion perpendicularly connecting the first planar surface to the second planar surface.

8. The building material of claim 7, wherein the first cap portion includes a subsection that is adjacent to at least a portion of the first core portion.

9. The building material of claim 8, wherein the first cap portion has a first thickness and the second cap portion has a second thickness.

10. The building material of claim 2, wherein the first cap portion and the second cap portion are connected by a third cap portion that is perpendicular to the first cap portion and the second cap portion and surrounds at least a portion of the core.

11. The building material of claim 1, wherein the thermoset polymer comprises a range of 0.1% and 20% by weight.

12. A polymer-based building material, comprising:
a core having a first planar surface and a second planar surface; and
a cap adjacent to the first planar surface, the cap including
a polymeric composition having a thermoplastic polymer and a thermoset polymer,
wherein the thermoset polymer in the polymeric composition is in a range of up to 20% by weight.

13. The building material of claim 12, wherein the thermoset polymer is a cross-linked high density polyethylene (HDPE).

14. The building material of claim 12, wherein the thermoplastic polymer comprises one or more of recycled high density polyethylene (HDPE), polypropylene (PP), or a virgin polymer.

15. The building material of claim 12, wherein the thermoplastic polymer comprises at least 80% of a polymer-based mixture by weight.

16. The building material of claim 12, wherein the thermoset polymer is 5% by weight.

17. The building material of claim 12, wherein the cap does not comprise cellulose.

18. The building material of claim 12, wherein the core includes a first core portion perpendicularly connecting the first planar surface to the second planar surface.

19. The building material of claim 18, wherein the cap further comprises:
a first cap portion having a subsection that is adjacent to at least a portion of the first core portion; and
a second cap portion, wherein the first cap portion has a first thickness and the second cap portion has a second thickness.

20. The building material of claim 19, wherein the first cap portion and the second cap portion are connected by a third cap portion that is perpendicular to the first cap portion and the second cap portion and surrounds at least a portion of the core.
